(19) United States
(12) Patent Application Publication
(10) Pub. No.: US 2011/0206209 A1
(43) Pub. Date: Aug. 25, 2011

(54) Apparatus

(75) Inventor: Pasi Ojala, Kirkkonummi (FI)

(73) Assignee: NOKIA CORPORATION, Espoo (FI)

(21) Appl. No.: 13/122,238

(22) PCT Filed: Oct. 3, 2008
(86) PCT No.: PCT/EP2008/063295

§ 371 Date: May 9, 2011

(51) Int. Cl. H04R 5/00

(52) U.S. Cl. 381/1

(57) ABSTRACT

An apparatus configured to determine at least one current phase difference between a first channel audio signal and a second channel audio signal for a current audio frame, calculate at least one phase difference estimate dependent on the at least one phase difference, determine a reliability value for each phase difference estimate, and determine at least one time delay value dependent on the reliability value for each phase difference estimate.

### FIELD OF THE INVENTION

The present invention relates to apparatus for coding of audio and speech signals. The invention further relates to, but is not limited to, apparatus for coding of audio and speech signals in mobile devices.

### BACKGROUND OF THE INVENTION

Spatial audio processing is an effect of an audio signal emanating from an audio source arriving at the left and right ears of a listener via different propagation paths. As a consequence of this effect the signal at the left ear will typically have a different arrival time and signal level to that of the corresponding signal arriving at the right ear. The difference between the times and signal levels are functions of the differences in the paths by which the audio signal travelled in order to reach the left and right ears respectively. The listener's brain then interprets these differences to give the perception that the received audio signal is being generated by an audio source located at a particular distance and direction relative to the listener.

An auditory scene therefore may be viewed as the net effect of simultaneously hearing audio signals generated by one or more audio sources located at various positions relative to the listener.

As the human brain can process a binaural input signal (such as provided by a pair of headphones) in order to ascertain the position and direction of a sound source may be used to code and synthesise auditory scenes. A typical method of spatial auditory coding attempts to model the salient features of an audio scene. This normally entails purposefully modifying audio signals from one or more different sources in order to generate left and right audio signals. In the art these signals may be collectively known as binaural signals. The resultant binaural signals may then be generated such that they give the perception of varying audio sources located at different positions relative to the listener.

Recently, spatial audio techniques have been used in connection with multi-channel audio reproduction. Multichannel audio reproduction provides efficient coding of multi channel audio signals typically two or more (a plurality) of separate audio channels or sound sources. Recent approaches to the coding of multichannel audio signals have centred on parametric stereo (PS) and Binaural Cue Coding (BCC) methods.

BCC methods typically encode the multi-channel audio signal by down mixing the various input audio signals into either a single (“sum”) channel or a smaller number of channels conveying the “sum” signal. The BCC methods then typically employ a low bit rate audio coding scheme to encode the sum signal or signals.

In parallel, the most salient inter channel cues, otherwise known as spatial cues, describing the multi-channel sound image or audio scene are extracted from the input channels and coded as side information.

Both the sum signal and side information form the encoded parameter set can then either be transmitted as part of a communication link or stored in a store and forward type device.

The BCC decoder then is capable of generating a multi-channel output signal from the received or stored sum signal and spatial cue information.

Further information regarding typical BCC techniques can be found in the following IEEE publication Binaural Cue Coding—Part II Schemes and Applications in IEEE Transactions on Speech and Audio Processing, Vol. 11, No 6, November 2003 by Baumgarte, F. and Faller, C.

As described above the down mix signals employed in spatial audio coding systems are typically encoded using low bit rate perceptual audio coding techniques such as the ISO/IEC Moving Pictures Expert Group Advanced Audio Coding standard to attempt to reduce the required bit rate.

In typical implementations of spatial audio multichannel coding the set of spatial cues may include an inter channel level difference parameter (ICLD) which models the relative difference in audio levels between two channels, and an inter channel time delay value (ICTD) which represents the time difference or phase shift of the signal between the two channels. The audio level and time differences are usually determined for each channel with respect to a reference channel. Alternatively some systems may generate the spatial audio cues with the aide of head related transfer function (HRTF). Further information on such techniques may be found in The Psychoacoustics of Human Sound Localization by J. Blaubert and published in 1983 by the MIT Press.

Another approach for representing inter channel audio cues uses a technique known as Uniform Domain Transformation (UDT). This approach attempts to model the multichannel audio signal as a set of vectors emanating from a number of audio sources, or audio channels. Each audio signal vector is then transformed from a physical or perceived auditory space to a mathematical defined space known as the unified domain. This transformation is typically performed in the form of a matrix operation, whereby the coefficients of the matrix are formed by considering the relative phase and panning coefficient for each audio vector. The effect in the auditory space of this transformation or mapping process is to rotate and project each vector such that it is aligned to a single principal component vector.

The UDT technique is akin to the signal processing technique known as Principal Component Analysis (PCA). In a UDT audio encoder the inter channel audio cues are represented by the parameters of the transformation matrix, and the down mixed sum signal is represented as the principal component vector. In fact the audio signal phase and panning components used to form the coefficients of the UDT transformation matrix are related respectively to the ICTD and ICLD parameters used within a conventional BCC coder. A more thorough treatment of unified domain audio processing may be found in the Audio Engineering Society journal article “Multichannel Audio Processing Using a Unified Domain Representation” by K. Short R. Garcia and M. Daniels, Vol. 55, No 3 Mar. 2007.

Although ICLD and ICTD parameters represent the most important spatial audio cues, spatial representations using these parameters may be further enhanced with the incorporation of an inter channel coherence (ICC) parameter. By incorporating such a parameter into the set of spatial audio cues the perceived spatial “diffuseness” or conversely the spatial “compactness” may be represented in the reconstructed signal.

Prior art methods of calculating ICTD values between each channel of a multichannel audio signal have been primarily focussed on calculating an optimum delay value between two separate audio signals. For instance the PCT patent application publication number WO 2006/060280 teaches a method based upon the calculation of the normalised cross correlation between two audio signals. The normalised cross correlation function is a function of the time difference or delay between the two audio signals. The prior art proposes calculating the normalised cross correlation function for a range of different time delay values. The ICTD value is then determined to be the delay value associated with the maximum normalised cross correlation.

Furthermore the PCT application teaches that the two audio signals are partitioned into audio processing frames in the time domain and then further partitioned into sub bands in the frequency domain. The spatial audio parameters, for example the ICTD values are calculated for each of the sub bands within each audio processing frame.

Prior art methods for determining ICTD values are typically memoryless, in other words calculated within the time frame of an audio processing frame without considering ICTD values from previous audio processing frames. It has been identified in a co-pending application (PWF Ref Number 318450 Nokia Ref NC 63129) PCT app No in relation to complexity reduction techniques for ICTD calculations that ICTD values may be determined by considering values from previous frames for each sub band.

However as with any coding parameter there is a need to calculate such parameters from the consideration of both reduced complexity and improved coding efficiency.

### SUMMARY OF THE INVENTION

This invention proceeds from the consideration that whilst the co pending application has addressed the problem of complexity reduction for the calculation of ICTD parameters, there is still additionally need to improve the coding efficiency and perceptual audio quality resulting from the coding process.

Embodiments of the present invention aim to address the above problem.

There is provided according to a first aspect of the invention a method comprising: determining at least one current phase difference between a first channel audio signal and a second channel audio signal for a current audio frame; calculating at least one phase difference estimate dependent on the at least one phase difference; determining a reliability value for each phase difference estimate; and determining at least one time delay value dependent on the reliability value for each phase difference estimate.

According to an embodiment determining the reliability value for each phase difference estimate comprises: determining a phase difference removed first channel audio signal; determining a phase difference removed second channel audio signal; and calculating a normalised correlation coefficient between the phase difference removed first channel audio signal and the phase difference removed second audio channel audio signal.

Determining the phase difference removed first channel audio signal may comprise: adapting the phase of the first channel audio signal by an amount corresponding to a first portion of the at least one phase difference estimate; and determining a phase difference removed second channel audio signal may comprise: adapting the phase of the second channel audio signal by an amount corresponding to a second portion of the at least one phase difference estimate.

Determining the at least one time delay value may comprise: determining a maximum reliability value from the reliability value for each of the at least one phase difference estimate; determining at least one further phase difference estimate from the at least one phase difference estimate associated with the maximum reliability value; and calculating the at least one time delay value by applying a scaling factor to the at least one further phase difference estimate.

Calculating the at least one phase difference estimate may comprise at least one of the following: calculating a first of the at least one phase difference estimate dependent on the at least one phase difference; and calculating a second of the at least one phase difference estimate dependent on the at least one phase difference.

Determining the at least one time delay value may comprise: determining whether the reliability value associated with the first of the at least one phase difference estimate is equal or above a predetermined value; assigning at least one further phase difference estimate to be the value of the first of the at least one phase difference estimate, wherein the assignment is dependent on the determination of the reliability value associated with the first of the at least one phase difference estimate; and calculating the at least one time delay value by applying a scaling factor to the at least one further phase difference estimate.

Determining the at least one time delay value may comprise: determining whether the reliability value associated with the first of the at least one phase difference estimate is below a predetermined value; assigning at least one further phase difference estimate to be the value of the first of the at least one phase difference estimate, wherein the assignment is dependent on the determination of the reliability value associated with the first of the at least one phase difference estimate; and calculating the at least one time delay value by applying a scaling factor to the at least one further phase difference estimate.

The scaling factor is preferably a phase to time scaling factor.

Calculating the first of the at least one phase difference estimate may comprise: providing a target phase value dependent on at least one preceding phase difference; calculating at least one distance value wherein each distance value is associated with one of the at least one current phase difference and the target phase value; determining a minimum distance value from the at least one distance measure value; and assigning the first of the at least one phase difference to be the at least one current phase difference associated with the minimum distance value.

Providing the target phase value may comprise at least one of the following: determining the target phase value from a median value of the at least one preceding phase difference value; and determining the target phase value from a moving average value of the at least one preceding phase difference value.

Calculating each of the at least one distance value may comprise determining the difference between the target value and the associated at least one current phase difference.

The at least one preceding phase difference preferably corresponds to at least one further phase estimate associated with a previous audio frame.

The at least one preceding phase difference is preferably updated with the further phase estimate for the current frame.

The updating of the at least one preceding phase difference with the further phase estimate for the current frame is preferably dependent on whether the maximum reliability value is greater than a predetermined value.

Determining the at least one current phase difference between a first channel audio signal and a second channel audio signal for a current audio frame may comprise; transforming the first channel audio signal into a first frequency domain audio signal comprising at least one frequency domain coefficient; transforming the second channel audio signal into a second frequency domain audio signal comprising at least one frequency domain coefficient; and determining the difference between the at least one frequency domain coefficient from the first frequency domain audio signal and the at least one frequency domain coefficient from the second frequency domain audio signal.

Calculating the second of the at least one phase difference estimate dependent on the at least one phase difference may comprise: determining the at least one current phase difference is preferably associated with at least one of the following; a maximum magnitude frequency domain coefficient from the first frequency domain audio signal; and a maximum magnitude frequency domain coefficient from the second frequency domain audio signal.

The at least one frequency coefficient is preferably a complex frequency domain coefficient comprising a real component and an imaginary component.

Determining the phase from the frequency domain coefficient may comprise: calculating the argument of the complex frequency domain coefficient. The argument is preferably determined as the arc tangent of the ratio of the real component to the imaginary component.

The complex frequency domain coefficient is preferably a discrete fourier transform coefficient.

The audio frame is preferably partitioned into a plurality of sub bands, and the method is applied to each sub band.

The phase to time scaling factor is preferably a normalised discrete angular frequency of a sub band signal associated with a corresponding sub band of the plurality of sub bands.

The at least one time delay value is preferably an inter channel time delay as part of a binaural cue coder.

According to a second aspect of the present invention there is provided an apparatus comprising a processor configured to: determine at least one current phase difference between a first channel audio signal and a second channel audio signal for a current audio frame; calculate at least one phase difference estimate dependent on the at least one phase difference; determine a reliability value for each phase difference estimate; and determine at least one time delay value dependent on the reliability value for each phase difference estimate.

According to an embodiment of the invention the apparatus configured to determine the reliability value for each phase difference estimate is may be further configured to: determine a phase difference removed first channel audio signal; determine a phase difference removed second channel audio signal; and calculate a normalised correlation coefficient between the phase difference removed first channel audio signal and the phase difference removed second audio channel audio signal.

The apparatus comprising a processor configured to determine the phase difference removed first channel audio signal may be further configured to: adapt the phase of the first channel audio signal by an amount corresponding to a first portion of the at least one phase difference estimate;

The apparatus comprising a processor configured to determine a phase difference removed second channel audio signal may be further configured to: adapt the phase of the second channel audio signal by an amount corresponding to a second portion of the at least one phase difference estimate.

The apparatus comprising a processor configured to determine the at least one time delay value may be further configured to: determine a maximum reliability value from the reliability value for each of the at least one phase difference estimate; determine at least one further phase difference estimate from the at least one phase difference estimate associated with the maximum reliability value; and calculate the at least one time delay value by applying a scaling factor to the at least one further phase difference estimate.

The apparatus configured to determine the at least one time delay value dependent on the reliability value for each of the at least one phase difference estimate may be further configured to: determine a maximum reliability value from the reliability value for each of the at least one phase difference estimate; determine at least one further phase difference estimate from the at least one phase difference estimate associated with the maximum reliability value; and calculate the at least one time delay value by applying a scaling factor to the at least one further phase difference estimate.

The apparatus configured to calculate the at least one phase difference estimate dependent on the at least one phase difference may be further configured to calculate at least one of the following: a first of the at least one phase difference estimate dependent on the at least one phase difference; and a second of the at least one phase difference estimate dependent on the at least one phase difference.

The apparatus configured to determine the at least one time delay value may be further configured to: determine whether the reliability value associated with the first of the at least one phase difference estimate is equal or above a pre determined value; assign at least one further phase difference estimate to be the value of the first of the at least one phase difference estimate, wherein the assignment is dependent on the determination of the reliability value associated with the first of the at least one phase difference estimate; and calculate the at least one time delay value by applying a scaling factor to the at least one further phase difference estimate.

The apparatus configured to determine the at least one time delay value may be further configured to: determine whether the reliability value associated with the first of the at least one phase difference estimate is below a predetermined value; assign at least one further phase difference estimate to be the value of the first of the at least one phase difference estimate, wherein the assignment is dependent on the determination of the reliability value associated with the first of the at least one phase difference estimate; and calculate the at least one time delay value by applying a scaling factor to the at least one further phase difference estimate.

The scaling factor is preferably phase to time scaling factor.

The apparatus configured to calculate the first of the at least one phase difference estimate may be further configured to: provide a target phase value dependent on at least one preceding phase difference; calculate at least one distance value wherein each distance value is associated with one of the at least one current phase difference and the target phase value; determine a minimum distance value from the at least one distance measure value; and assign the first of the at least one phase difference to be the at least one current phase difference associated with the minimum distance value.

The apparatus configured to provide the target phase value may be further configured to determine at least one of the following: the target phase value from a median value of the at least one preceding phase difference value; and the target phase value from a moving average value of the at least one preceding phase difference value.

The apparatus configured to calculate each of the at least one distance value may be further configured to determine the difference between the target value and the associated at least one current phase difference.

The at least one preceding phase difference preferably corresponds to at least one further phase estimate associated with a previous audio frame.

The at least one preceding phase difference is preferably updated with the further phase estimate for the current frame.

The updating of the at least one preceding phase difference with the further phase estimate for the current frame is preferably dependent on whether the maximum reliability value is greater than a predetermined value.

The apparatus configured to determine the at least one current phase difference between a first channel audio signal and a second channel audio signal for a current audio frame may be further configured to; transform the first channel audio signal into a first frequency domain audio signal comprising at least one frequency domain coefficient; transform the second channel audio signal into a second frequency domain audio signal comprising at least one frequency domain coefficient; and determine the difference between the at least one frequency domain coefficient from the first frequency domain audio signal and the at least one frequency domain coefficient from the second frequency domain audio signal.

the apparatus configured to calculate the second of the at least one phase difference estimate dependent on the at least one phase difference may be further configured to: determine the at least one current phase difference associated with at least one of the following; a maximum magnitude frequency domain coefficient from the first frequency domain audio signal; and a maximum magnitude frequency domain coefficient from the second frequency domain audio signal.

The at least one frequency coefficient is preferably a complex frequency domain coefficient comprising a real component and an imaginary component, and the apparatus configured to determine the phase from the frequency domain coefficient may be further configured to calculate the argument of the complex frequency domain coefficient, wherein the argument is determined as the arc tangent of the ratio of the real component to the imaginary component.

The complex frequency domain coefficient is preferably a discrete fourier transform coefficient.

The audio frame is preferably partitioned into a plurality of sub bands, and the apparatus is configured to process each sub band.

The phase to time scaling factor is preferably a normalised discrete angular frequency of a sub band signal associated with a corresponding sub band of the plurality of sub bands.

The at least one time delay value is preferably an inter channel time delay as part of a binaural cue coder.

An audio encoder may comprise an apparatus comprising a processor as claimed above.

An electronic device may comprise an apparatus comprising a processor as claimed above.

A chipset may comprise an apparatus as described above.

According to a third aspect of the present invention there is provided a computer program product configured to perform a method comprising: determining at least one current phase difference between a first channel audio signal and a second channel audio signal for a current audio frame; calculating at least one phase difference estimate dependent on the at least one phase difference; determining a reliability value for each phase difference estimate; and determining at least one time delay value dependent on the reliability value for each phase difference estimate.

### BRIEF DESCRIPTION OF DRAWINGS

For better understanding of the present invention, reference will now be made by way of example to the accompanying drawings in which:

FIG. 1 shows schematically an electronic device employing embodiments of the invention;

FIG. 2 shows schematically an audio encoder system employing embodiments of the present invention;

FIG. 3 shows schematically an audio encoder deploying a first embodiment of the invention;

FIG. 4 shows a flow diagram illustrating the operation of the encoder according to embodiments of the invention;

FIG. 5 shows schematically a down mixer according to embodiments of the invention;

FIG. 6 shows schematically a spatial audio cue analyser according to embodiments of the invention;

FIG. 7 shows an illustration depicting the distribution of ICTD and ICLD values for each channel of a multichannel audio signal system comprising M input channels;

FIG. 8 shows a flow diagram illustrating in further detail the operation of the invention according to embodiments of the invention;

FIGS. 9 and 10 shows a flow diagram illustrating in yet further detail the operation of the invention according to embodiments of the invention; and

FIG. 11 shows a flow diagram illustrating still yet further detail the operation of the invention according to embodiments of the invention.

### DESCRIPTION OF PREFERRED EMBODIMENTS OF THE INVENTION

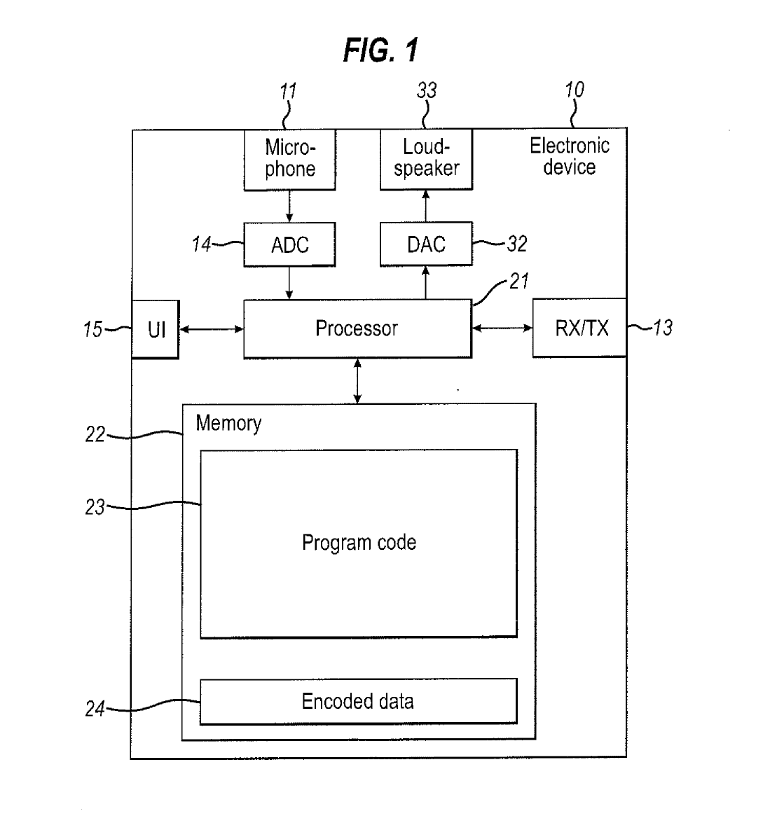

The following describes apparatus and methods for the provision of enhancing spatial audio cues for an audio codec. In this regard reference is first made to FIG. 1 schematic block diagram of an exemplary electronic device 10 or apparatus, which may incorporate a codec according to an embodiment of the invention.

The electronic device 10 may for example be a mobile terminal or user equipment of a wireless communication system.

The electronic device 10 comprises a microphone 11, which is linked via an analogue-to-digital converter 14 to a processor 21. The processor 21 is further linked via a digital-to-analogue converter 32 to loudspeakers 33. The processor 21 is further linked to a transceiver (TX/RX) 13, to a user interface (UI) 15 and to a memory 22.

The processor 21 may be configured to execute various program codes. The implemented program codes comprise an audio encoding code for encoding a lower frequency band of an audio signal and a higher frequency band of an audio signal. The implemented program codes 23 further comprise an audio decoding code. The implemented program codes 23 may be stored for example in the memory 22 for retrieval by the processor 21 whenever needed. The memory 22 could further provide a section 24 for storing data, for example data that has been encoded in accordance with the invention.

The encoding and decoding code may in embodiments of the invention be implemented in hardware or firmware.

The user interface 15 enables a user to input commands to the electronic device 10, for example via a keypad, and/or to obtain information from the electronic device 10, for example via a display. The transceiver 13 enables a communication with other electronic devices, for example via a wireless communication network.

It is to be understood again that the structure of the electronic device 10 could be supplemented and varied in many ways.

A user of the electronic device 10 may use the microphone 11 for inputting speech that is to be transmitted to some other electronic device or that is to be stored in the data section 24 of the memory 22. A corresponding application has been activated to this end by the user via the user interface 15. This application, which may be run by the processor 21, causes the processor 21 to execute the encoding code stored in the memory 22.

The analogue-to-digital converter 14 converts the input analogue audio signal into a digital audio signal and provides the digital audio signal to the processor 21.

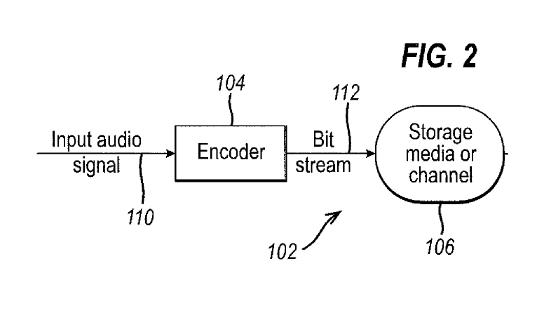

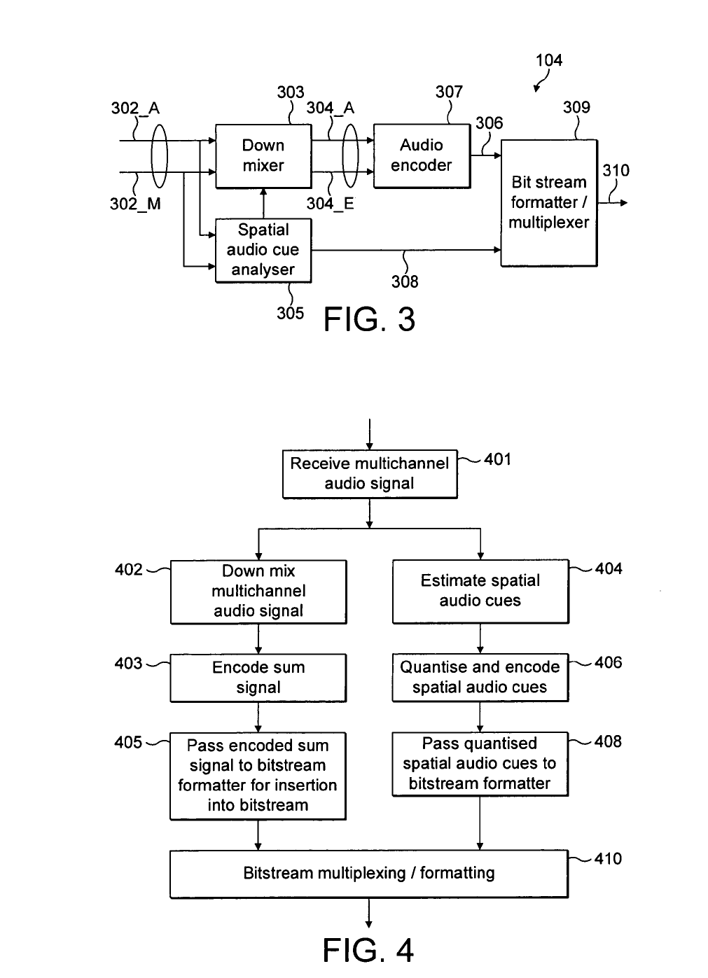

The processor 21 may then process the digital audio signal in the same way as described with reference to FIGS. 2 and 3.

The resulting bit stream is provided to the transceiver 13 for transmission to another electronic device. Alternatively, the coded data could be stored in the data section 24 of the memory 22, for instance for a later transmission or for a later presentation by the same electronic device 10.

The electronic device 10 could also receive a bit stream with correspondingly encoded data from another electronic device via its transceiver 13. In this case, the processor 21 may execute the decoding program code stored in the memory 22. The processor 21 decodes the received data, and provides the decoded data to the digital-to-analogue converter 32. The digital-to-analogue converter 32 converts the digital decoded data into analogue audio data and outputs them via the loudspeakers 33. Execution of the decoding program code could be triggered as well by an application that has been called by the user via the user interface 15.

The received encoded data could also be stored instead of an immediate presentation via the loudspeakers 33 in the data section 24 of the memory 22, for instance for enabling a later presentation or a forwarding to still another electronic device.

It would be appreciated that the schematic structures described in FIGS. 2, 3, 5 and 6 and the method steps in FIGS. 4, 9, 10 and 11 represent only a part of the operation of a complete audio codec comprising an embodiments of the invention as exemplarily shown implemented in the electronic device shown in FIG. 1.

The general operation of audio encoders as employed by embodiments of the invention is shown in FIG. 2. General audio coding systems consist of an encoder, as illustrated schematically in FIG. 2. Illustrated is a system 102 with an encoder 104 and a storage or media channel 106.

The encoder 104 compresses an input audio signal 110 producing a bit stream 112, which is either stored or transmitted through a media channel 106. The bit rate of the bit stream 112 and the quality of any resulting output audio signal in relation to the input signal 110 are the main features which define the performance of the coding system 102.

FIG. 3 shows schematically an encoder 104 according to a first embodiment of the invention. The encoder 104 is depicted as comprising an input 302 divided into M channels. It is to be understood that the input 302 may be arranged to receive either an audio signal of M channels, or alternatively M audio signals from M individual audio sources. Each of the M channels of the input 302 may be connected to both a down mixer 303 and a spatial audio cue analyser 305. It would be understood that M could be any number greater than 2.

The down mixer 303 may be arranged to combine each of the M channels into a sum signal 304 comprising a representation of the sum of the individual audio input signals. In some embodiments of the invention the sum signal 304 may comprise a single channel. In other embodiments of the invention the sum signal 304 may comprise a plurality of channels, which in FIG. 3 is represented by E channels where E is less than M.

The sum signal output 304 from the down mixer 303 may be connected to the input of an audio encoder 307. The audio decoder 307 may be configured to encode the audio sum signal 304 and output a parameterised encoded audio stream 306.

The spatial audio cue analyser 305 may be configured to accept the M channel audio input signal from the input 302 and generate as output a spatial audio cue signal 308. The output signal from the spatial cue analyser 305 may be arranged to be connected to the input of a bit stream formatter 309 (which in some embodiments of the invention may also known as the bitstream multiplexer).

In some embodiments of the invention there may be an additional output connection from the spatial audio cue analyser 305 to the down mixer 303, whereby spatial audio cues such as the ICTD spatial audio cues may be fed back to the down mixer on order to remove the time difference between channels.

In addition to receiving the spatial cue information from the spatial cue analyser 305, the bitstream formatter 309 may be further arranged to receive as an additional input the output from the audio encoder 307. The bitstream formatter 309 may then configured to output the output bitstream 112 via the output 310.

The operation of these components is described in more detail with reference to the flow chart in FIG. 4 showing the operation of the encoder.

The multichannel audio signal is received by the encoder 104 via the input 302. In a first embodiment of the invention the audio signal from each channel is a digitally sampled signal. In other embodiments of the present invention the audio input may comprise a plurality of analogue audio signal sources, for example from a plurality of microphones distributed within the audio space, which are analogue to digitally (A/D) converted. In further embodiments of the invention the multichannel audio input may be converted from a pulse code modulation digital signal to an amplitude modulation digital signal.

The receiving of the audio signal is shown in FIG. 4 by processing step 401.

The down mixer 303 receives the multichannel audio signal and combines the M input channels into a reduced number of channels E conveying the sum of the multichannel input signal. It is to be understood that the number of channels E to which the M input channels may be down mixed may comprise either a single channel or a plurality of channels.

In embodiments of the invention the down mixing may take the form of adding all the M input signals into a single channel comprising of the sum signal. In this example of an embodiment of the invention E may be equal to one.

In further embodiments of the invention the sum signal may be computed in the frequency domain, by first transforming each input channel into the frequency domain using a suitable time to frequency transform such as a discrete fourier transform (DFT).

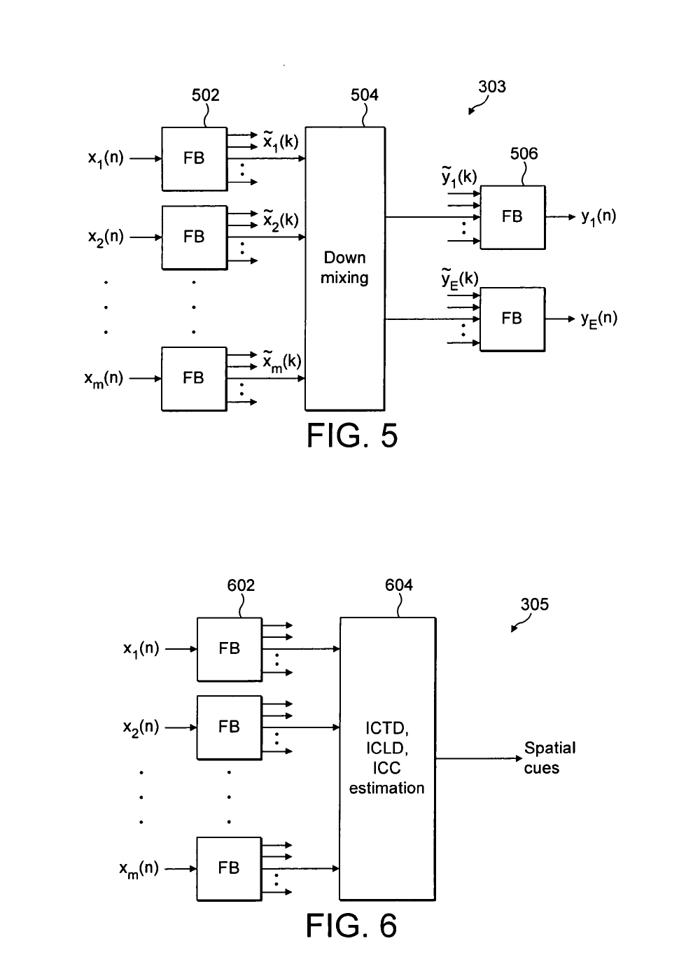

FIG. 5 shows a block diagram depicting a generic M to E down mixer which may be used for the purposes of down mixing the multichannel input audio signal according to embodiments of the invention. The down mixer 303 in FIG. 5 is shown as having a filter bank 502 for each time domain input channel xᵢ(n) where i is the input channel number for a time instance n. In addition the down mixer 303 is depicted as having a down mixing block 504, and finally an inverse filter bank 506 which may be used to generate the time domain signal for each output down mixed channel yᵢ(n).

In embodiments of the invention each filter bank 502 may convert the time domain input for a specific channel xᵢ(n) into a set of K sub bands. The set of sub bands for a particular channel i may be denoted as \tilde{X}ᵢ=[\tilde{x}ᵢ(0), \tilde{x}ᵢ(1), . . . , \tilde{x}ᵢ(k) . . . , \tilde{x}ᵢ(K−1)] where \tilde{x}ᵢ(k) represents the individual sub band k. In total there may be M sets of K sub bands, one for each input channel. The M sets of K sub bands may be represented as [\tilde{X}₀, \tilde{X}₁, . . . \tilde{X}_{M-1}].

In embodiments of the invention the down mixing block 504 may then down mix a particular sub band with the same index from each of the M sets of frequency coefficients in order to reduce the number of sets of sub bands from M to E. This may be accomplished by multiplying the particular k^{th} sub band from each of the M sets of sub bands bearing the same index by a down mixing matrix in order to generate the k^{th} sub band for the E output channels of the down mixed signal. In other words the reduction in the number of channels may be achieved by subjecting each sub band from a channel by a matrix reduction operation. The mechanics of this operation may be represented by the following mathematical operation

$$[ \begin{matrix}{\tilde{y}}_{1} ( k ) \\ {\tilde{y}}_{2} ( k ) \\ ⋮ \\ {\tilde{y}}_{E} ( k )\end{matrix} ] = {D}_{EM} [ \begin{matrix}{\tilde{x}}_{1} ( k ) \\ {\tilde{x}}_{2} ( k ) \\ ⋮ \\ {\tilde{x}}_{M} ( k )\end{matrix} ]$$

where D_{EM} may be a real valued E by M matrix, [\tilde{x}₁(k), \tilde{x}₂(k), . . . \tilde{x}_{M}(k)] denotes the k^{th} sub band for each input sub band channel, and [\tilde{y}₁(k), \tilde{y}₂(k), . . . \tilde{y}_{E}(k)] represents the k^{th} sub band for each of the E output channels.

In other embodiments of the invention the D_{EM} may be a complex valued E by M matrix. In embodiments such as these the matrix operation may additionally modify the phase of the domain transform domain coefficients in order to remove any inter channel time difference.

The output from the down mixing matrix D_{EM} may therefore comprise of E channels, where each channel may consist of a sub band signal comprising of K sub bands, in other words if Yᵢ represents the output from the down mixer for a channel i at an input frame instance, then the sub bands which comprise the sub band signal for channel i may be represented as the set [\tilde{y}ᵢ(0), \tilde{y}ᵢ(1), . . . \tilde{y}ᵢ(k−1)].

Once the down mixer has down mixed the number of channels from M to E, the K frequency coefficients associated with each of the E channels \tilde{Y}ᵢ=[\tilde{y}ᵢ(0), \tilde{y}ᵢ(1), . . . \tilde{y}ᵢ(k) . . . , \tilde{y}ᵢ(K−1)] may be converted back to a time domain output channel signal yᵢ(n) using an inverse filter bank as depicted by the inverse filter bank block 506 in FIG. 5, thereby enabling the use of any subsequent audio coding processing stages.

In yet further embodiments of the invention the frequency domain approach may be further enhanced by dividing the spectrum for each channel into a number of partitions. For each partition a weighting factor may be calculated comprising the ratio of the sum of the powers of the frequency components within each partition for each channel to the total power of the frequency components across all channels within each partition. The weighting factor calculated for each partition may then be applied to the frequency coefficients within the same partition across all M channels. Once the frequency coefficients for each channel have been suitably weighted by their respective partition weighting factors the weighted frequency components from each channel may be added together in order to generate the sum signal. The application of this approach may be implemented as a set of weighting factors for each channel and may be depicted as the optional scaling block placed in between the down mixing stage 504 and the inverse filter bank 506.

By using this approach for combining and summing the various channels allowance is made for any attenuation and amplification effects that may be present when combining groups of inter related channels. Further details of this approach may be found in the IEEE publication Transactions on Speech and Audio Processing, Vol. 11, No 6 Nov. 2003 entitled, Binaural Cue Coding—Part II: Schemes and Applications, by Christof Faller and Frank Baumgate.

The down mixing and summing of the input audio channels into a sum signal is depicted as processing step 402 in FIG. 4.

The spatial cue analyser 305 may receive as an input the multichannel audio signal. The spatial cue analyser may then use these inputs in order to generate the set of spatial audio cues which in embodiments of the invention may consist of the Inter channel time difference (ICTD), inter channel level difference (ICLD) and the inter channel coherence (ICC) cues.

In embodiments of the invention stereo and multichannel audio signals usually contain a complex mix of concurrently active source signals superimposed by reflected signal components from recording in enclosed spaces. Different source signals and their reflections occupy different regions in the time-frequency plane. This complex mix of concurrently active source signals may be reflected by ICTD, ICLD and ICC values, which may vary as functions of frequency and time. In order to exploit these variations it may be advantageous to analyse the relation between the various auditory cues in a sub band domain.

To further assist the understanding of the invention the process of determining the spatial audio cues by the spatial audio cue analyser 305 is described in more detail with reference to the flow chart in FIG. 8.

The step of receiving the multichannel audio signal at the spatial audio cue analyser, the processing step 401 from FIG. 4, is depicted as processing step 901 in FIG. 8.

In embodiments of the invention the frequency dependence of the spatial audio cues ICTD, ICLD and ICC present in a multichannel audio signal may be estimated in a sub band domain and at regular instances in time.

The estimation of the spatial audio cues may be realised in the spatial cue analyser 305 by using a fourier transform based filter bank analysis technique such as a Discrete Fourier Transform (DFT). In this embodiment a decomposition of the audio signal for each channel may be achieved by using a block-wise short time discrete fourier transform with a 50% overlapping analysis window structure.

It is to be understood in embodiments of the invention that the fourier transform based filter bank analysis may be performed independently for each channel of the input multichannel audio signal.

The frequency spectrum for each input channel i, as derived from the fourier transform based filter bank analysis may then be divided by the spatial audio cue analyser 305 into a number of non overlapping sub bands.

In other embodiments of the invention the frequency bands for each channel may be grouped in accordance with a linear scale, whereby the number of frequency coefficients for each channel may be apportioned equally to each sub band.

In further embodiments of the invention decomposition of the audio signal for each channel may be achieved using a quadrature mirror filter (QMF) with sub bands proportional to the critical bandwidth of the human auditory system.

The spatial cue analyser 305 may then calculate an estimate of the power of the frequency components within a sub band for each channel. In embodiments of the invention this estimate may be achieved for complex fourier coefficients by calculating the modulus of each coefficient and then summing the square of the modulus for all coefficients within the sub band. These power estimates may be used partly as the basis by which the spatial cue analyser 305 calculates the audio spatial cues.

FIG. 6 depicts a structure which may be used to generate the spatial audio cues from the multichannel input signal 302. In FIG. 6 a time domain input channel may be represented as xᵢ(n) where i is the input channel number and n is an instance in time. The sub band output from the filter bank (FB) 602 for each channel may be depicted as the set [\tilde{x}ᵢ(0), \tilde{x}ᵢ(1), . . . \tilde{x}ᵢ(k) . . . , \tilde{x}ᵢ(K−1)] where \tilde{x}ᵢ(k) represents the individual sub band k for a channel i.

In embodiments of the invention the filter bank 602 may be implemented as a discrete fourier transform filter (DFT) bank whereby the output from the bank for a channel i may comprise the set of frequency coefficients associated with the DFT. In such embodiments the set [\tilde{x}ᵢ(0), \tilde{x}ᵢ(1), . . . \tilde{x}ᵢ(k) . . . , \tilde{x}ᵢ(K−1)] may represent the frequency coefficients of the DFT.

The DFT may be determined according to the following equation

$${\hat{x}}_{i} ( q ) = {\sum }_{n = 0}^{N - 1} {x}_{i} ( n ) {e}^{- j 2 π qn / N}$$

$$q = \{ 0 , … , N - 1 \} ,$$

where i is the input channel number for a time instance n, and N is the number of time samples over which the DFT is calculated. In embodiments of the invention the frequency coefficients \hat{x}ᵢ(q) may also be referred to as frequency bins.

In embodiments of the invention the filter bank 602 may be referred to as a critically sampled DFT filter bank, whereby the number of filter coefficients is equal to the number of time samples used as input to the filter bank on a frame by frame basis.

It is to be understood in the art that a single DFT or frequency coefficient from a critically sampled filter bank may be referred to as an individual sub band of the filter bank. In this instance each DFT coefficient \hat{x}ᵢ(q) may therefore be equivalent to the individual sub band \tilde{x}ᵢ(k).

However, it is to be further understood that in embodiments of the invention the term sub band may also be used denote a group of closely associated frequency coefficients, where each coefficient within the group is derived from the filter bank 602 (or DFT transform).

In embodiments of the invention the fourier transform based filter bank analysis may be performed independently for each channel of the input multichannel audio signal.

In further embodiments of the invention the DFT filter bank may be implemented in an efficient form as a fast fourier transform (FFT).

The process of transforming each channel of the multichannel audio signal into a frequency domain coefficient representation by the filter bank (FB) 602 is depicted as processing step 903 in FIG. 8.

The frequency coefficient spectrum for each input channel i, as derived from the filter bank analysis, may be partitioned by the spectral analyser 305 into a number of non overlapping sub bands, whereby each sub band may comprise a plurality of OFT coefficients.

In embodiments of the invention the frequency coefficients for each input channel may be distributed to each sub band according to a psychoacoustic critical band structure, whereby sub bands associated with a lower frequency region may be allocated fewer frequency coefficients than sub bands associated with a higher frequency region. In these embodiments of the invention the frequency coefficients \hat{x}ᵢ(q) for each input channel i may be distributed according to an equivalent rectangular bandwidth (ERB) scale. In such embodiments a sub band k may be represented by the set of frequency components whose indices lie within the range

k={q_{sb(k)}, . . . ,q_{sb(k)+1}−1}

where q_{sb(k)} represents the index of the first frequency coefficient in sub band k and q_{sb(k)+1} represents the index of the first coefficient for the following sub band k+1. Therefore the sub band k may comprise the frequency coefficients whose indices lie it the range from q_{sb(k)} to q_{sb(k)+1}−1. The number of frequency coefficients apportioned to the sub band k may be determined according to the ERB scale.

It is to be understood that all subsequent processing steps are performed on the input audio signal on a per sub band basis.

The process of partitioning each frequency domain channel of the multichannel audio signal into a plurality of sub bands comprising one or more frequency coefficients is depicted as processing step 905 in FIG. 8.

Once each audio signal channel has been transformed into a frequency domain sub band representation the spatial audio cues may then be estimated between the channels of the multichannel audio signal on a per sub band basis.

Initially, the inter channel level difference (ICLD) between each channel of the multichannel audio signal may be calculated for a particular sub band within the frequency spectrum. This calculation may be repeated for each sub band within the multichannel audio signal's frequency spectrum.

In embodiments of the invention which deploy a stereo or two channel input to the encoder 104, the ICLD between the left and right channel for each sub band k may be given by the ratio of the respective powers estimates of the frequency coefficients within the sub band. For example, the ICLD between the first and second channel ΔL₁₂(k) for the corresponding DFT coefficient signals \hat{x}₁(q) and \hat{x}₂(q) may be determined in decibels to be

$$Δ {L}_{12} ( k ) = 10 {log}_{10} ( \frac{{p}_{{\hat{x}}_{2}} ( k )}{{p}_{{\hat{x}}_{1}} ( k )} )$$

where the audio signal channels are denoted by indices 1 and 2, and the value k is the sub band index. The sub band index k may be used to signify the set of frequency indices assigned to the sub band in question. In other words the sub band k may comprise the frequency coefficients whose indices lie in the range from q_{sb(k)} to q_{sb(k)+1}−1.

The variables p_{\hat{x}}_{₂}(k) and p_{\hat{x}}_{₁}(k) are short time estimates of the power of the signals \hat{x}₁(q) and \hat{x}₂(q) over the sub band k, and may be determined respectively according to

$${p}_{{\hat{x}}_{2}} ( k ) = {\sum }_{q = {q}_{sb ( k )}}^{{q}_{sb ( k ) + 1} - 1} {\hat{x}}_{2} ( q ) {\hat{x}}_{2} ( q )$$

$$and$$

$${p}_{\hat{x} 1} ( k ) = {\sum }_{q = {q}_{sb ( k )}}^{{q}_{sb ( k ) + 1} - 1} {\hat{x}}_{1} ( q ) {\hat{x}}_{1} ( q )$$

In other words, the short time power estimates may be determined to be the sum of the square of the frequency coefficients assigned to the particular sub band k.

Processing of the frequency coefficients for each sub band in order to determine the inter channel level differences between two channels is depicted as processing step 907 in FIG. 8.

The spatial analyser 305 may also use the frequency coefficients from the DFT filter bank analysis stage to determine the ICTD value for each sub band between a pair of audio signals.

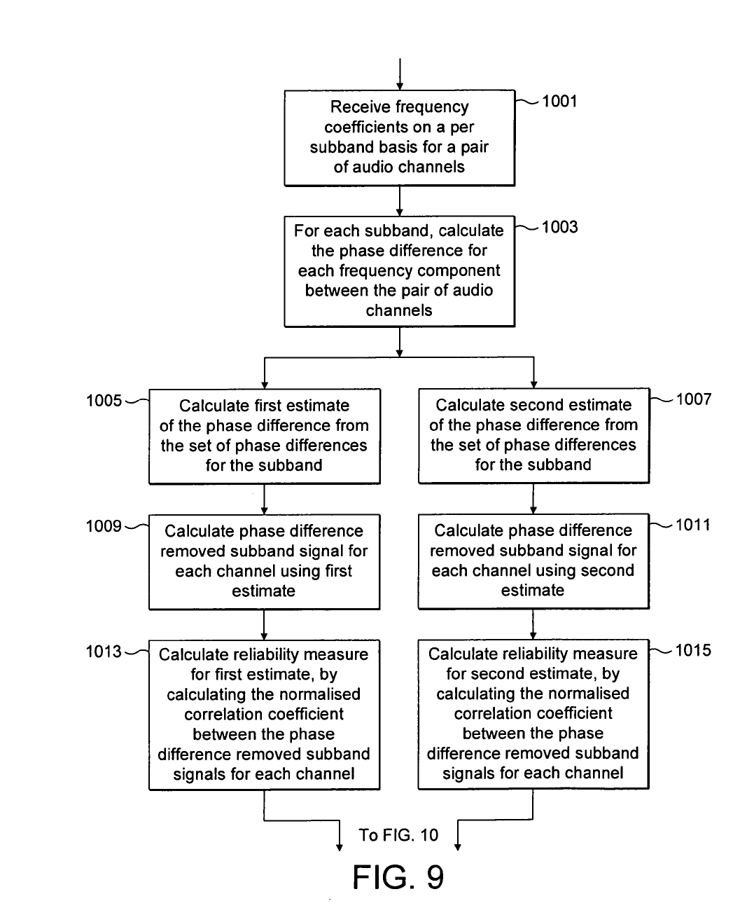

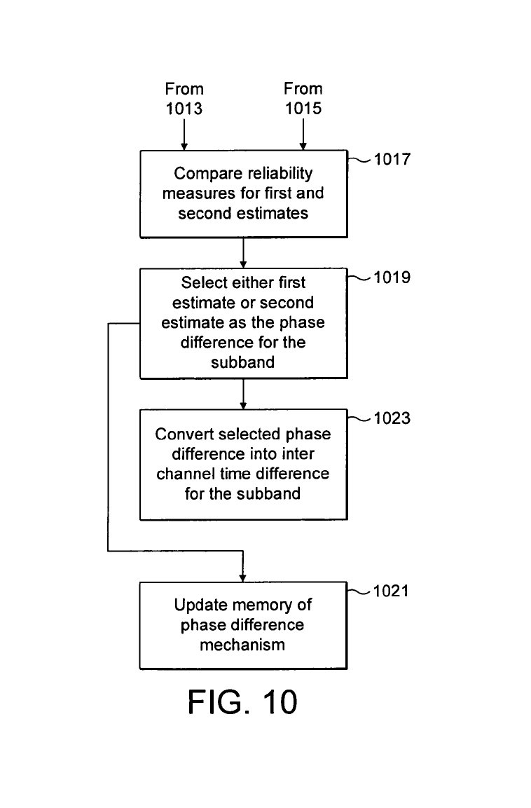

To further assist the understanding of the invention the process of determining the ICTD for each sub band between a pair of audio signals by the spatial audio cue analyser 305 is described in more detail with reference to the flow chart in FIGS. 9 and 10.

The ICTD value for each sub band between a pair of audio signals may be found by observing that the DFT coefficients produced by the filter bank 602 are complex in nature and therefore the argument of the complex DFT coefficient may be used to represent the phase of the sinusoid associated with the coefficient. The difference in phase between a frequency component from an audio signal emanating from a first channel and an audio signal emanating from a second channel may be used to indicate the time difference between the two channels at a particular frequency. The same principle may be applied to the sub bands between two audio signals where each sub band may comprise one or more frequency components. In other words, if a phase value is determined for a sub band within an audio signal from a first channel and a phase value is determined for the same sub band value within an audio signal from a second channel then the difference between the two phase values may be used to indicate the time difference between the audio signals from two channels for a particular sub band.

In general, the phase φᵢ(q) of a frequency coefficient q of a real audio channel signal xᵢ(n) may be formulated according to the argument of the following complex expression:

$$\begin{matrix}{φ}_{i} ( q ) = arg ( {\hat{x}}_{i} ( q ) ) \\ = arg ( {\sum }_{n = 0}^{N - 1} {x}_{i} ( n ) ( cos ( 2 π qn / N ) + j {\sum }_{n = 0}^{N - 1} {x}_{i} ( n ) ( sin ( 2 π qn / N ) ) .\end{matrix}$$

Using this formulation, the phase φᵢ(q) for a channel i and frequency coefficient q may be expressed as:

$${φ}_{i} ( q ) = arg ( X + j Y ) , \\ where$$

$$X = {\sum }_{n = 0}^{N - 1} {x}_{i} ( n ) ( cos ( 2 π qn / N ) and \\ Y = {\sum }_{n = 0}^{N - 1} {x}_{i} ( n ) ( sin ( 2 π qn / N ) .$$

By adopting the above terminology and noting that the argument of a complex number is an arc tangent function, the phase φᵢ(q) for a channel i and frequency coefficient k may be further formulated according to the following expression:

$${φ}_{i} ( q ) = arg ( X + j Y ) = \{ \begin{matrix}arctan ( \frac{Y}{X} ) & X > 0 \\ π + arctan ( \frac{Y}{X} ) & Y \geq 0 , X < 0 \\ - π + arctan ( \frac{Y}{X} ) & Y < 0 , X < 0 \\ \frac{π}{2} & Y > 0 , X = 0 \\ - \frac{π}{2} & Y < 0 , X = 0.\end{matrix}$$

In embodiments of the invention the phase difference α₁₂(q) between a first channel and a second channel of a multichannel audio signal for a frequency coefficient q may be determined as:

α₁₂(q)=φ₁(q)−φ₂(q).

It is to be understood that α₁₂(q) may lie within the range {−2π, . . . , 2π}.

In embodiments of the invention the time difference between the two audio signals for the frequency coefficient q may be determined by normalising the difference in phase α₁₂(q) of the two audio signals by a factor which represents the discrete angular frequency for the frequency coefficient q. In other words the inter channel time difference (ICTD) in unit samples between two audio signals for a single frequency component q may be expressed according to the following equation:

$${τ}_{12} ( q ) = {α}_{12} ( q ) \cdot \frac{N}{2 π q} ,$$

where τ₁₂(q) is the ICTD value between audio signals from two channels, and the factor

$$\frac{2 π q}{N}$$

is the discrete angular frequency for the frequency component q.

The above expression may also be viewed as the ICTD value between an audio signal from a first channel and an audio signal from a second channel for a sub band comprising of a single frequency coefficient.

It is to be understood in embodiments of the invention that the ICTD and the phase difference between channels, otherwise known as inter channel phase difference (ICPD), are terms which effectively represent the same physical quantity. The only difference between the ICTD and ICPD is a conversion factor which takes into account the discrete angular frequency of the sinusoid to which these two terms refer.

The process of receiving the frequency coefficients from the DFT analysis filter bank stage to be used to determine the ICTD value for each sub band between a pair of audio signals is depicted as processing step 1001 in FIG. 9.

As stated above some embodiments of the invention may partition the frequency spectrum for each channel into a number of non overlapping sub bands, where each sub band may be apportioned a plurality of frequency coefficients. For such embodiments it may be preferable to determine a single phase difference value for each sub band across multiple audio channels rather than allocating a phase difference value for every frequency coefficient within the sub band.

In embodiments of the invention this may be achieved by firstly determining for each frequency coefficient within a sub band a value for the phase difference between a frequency coefficient from a first audio channel and the corresponding frequency coefficient from a second audio channel. This may be performed for all frequency coefficients such that each sub band of the multichannel audio signal comprises a set of phase difference values.

The processing step of calculating the difference in phase for each frequency component within a sub band between a pair of audio signals is depicted as processing step 1003 in FIG. 9.

A first estimate of the phase difference may then be determined by selecting a particular phase difference from the set of phase differences for each sub band.

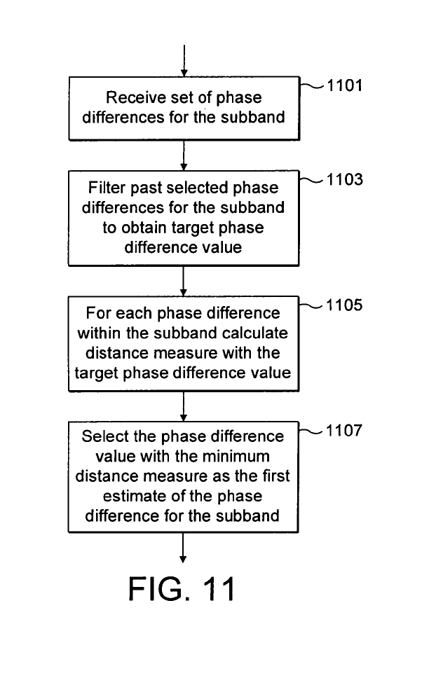

To further assist the understanding of the invention the process of determining the first estimate of the phase difference for each sub band by the spatial cue analyser 305 is described in more detail with reference to the flow chart in FIG. 11.

The step of receiving the set of phase difference values for a particular sub band from which the first estimate of the phase difference may be obtained is depicted as processing step 1101 in FIG. 11.

In embodiments of the invention the first estimate of the phase difference for each sub band may be determined by considering past phase differences which have been selected for previous processing frames. This may be deployed by adopting a filtering mechanism whereby past selected phase differences for each sub band may be filtered on an audio processing frame by audio processing frame basis. The filtering functionality may comprise filtering past selected phase difference values within a particular sub band in order to generate a target estimate of the phase difference for each sub band.

The processing step of filtering past selected phase difference values in order to generate a target estimate of the phase difference for each sub band is depicted as processing step 1103 in FIG. 11.

The target estimate of the phase difference value may then be used as a reference whereby a phase difference value may be selected for the current processing frame from the set of phase differences within the sub band. This may be accomplished by calculating a distance measure between a phase difference within the sub band and the target estimate phase difference for the sub band. The calculation of the distance measure may be done in turn for each phase difference value within the sub band.

The step of determining the distance measure between each phase difference value in the sub band and the target estimate phase difference is depicted as processing step 1105 in FIG. 11.

The first estimate of the phase difference for the sub band may then be determined to be the phase difference value which is associated with the smallest distance.

The step of selecting the first estimate phase difference value for the sub band is depicted as processing step 1107 in FIG. 11.

In embodiments of the invention the phase difference filtering mechanism may be arranged in the form of a first-in-first-out (FIFO) buffer. In the FIFO buffer arrangement each FIFO buffer memory store contains a number of past selected phase difference values for the particular sub band in question, with the most recent values at the start of the buffer and the oldest values at the end of the buffer. The past selected phase difference values stored within the buffer may then be filtered in order to generate the target estimate phase difference value.

In embodiments of the invention filtering the past selected phase difference values for a particular sub band may take the form of finding the median of the past selected phase difference values in order to generate the target estimate phase difference value.

In other embodiments of the invention filtering the past selected phase difference values for a particular sub band may take the form of performing a moving average (MA) estimation of the past selected phase difference values in order to generate the target estimated phase difference value. In such embodiments the MA estimation may be implemented by calculating the mean of the past selected phase difference values contained within the buffer memory for the current audio processing frame.

In some embodiments of the invention the MA estimation may be calculated over the entire length of the memory buffer.

In other embodiments of the invention the MA estimation may be calculated over part of the length of the memory buffer. For example, the MA estimation may be calculated over the most recent past selected phase difference values.

The effect of filtering past selected phase difference values for each sub band is to maintain a continuity of transition for phase difference values from audio processing frame to the next. In other words by selecting the phase difference according to the first estimate will result in a selected value being biased in favour of maintaining a phase difference track which evolves smoothly from one processing frame to the next.

The process of determining the first estimate of the phase difference for each sub band by the spatial cue analyser 305 is shown as processing step 1005 in FIG. 9.

Embodiments of the invention may determine an additional or second estimate of the phase difference for each sub band. The second estimate may be determined using a different technique to that deployed for the primary estimate. For example, in embodiments of the invention the second estimate of the phase difference for each sub band may be determined to be the phase difference associated with the largest magnitude frequency coefficient within the sub band.

It is to be understood that further embodiments of the invention may calculate a number of phase difference estimation schemes over each sub band, and that each phase difference estimation scheme may differ from each other. The process of determining a second estimate or additional estimates of the phase difference for each sub band by the spatial cue analyser 305 is shown as processing step 1007 in FIG. 9.

Once one or more phase difference estimates have been determined for each sub band across the multichannel audio signal. The phase differences may then be used to generate a corresponding number of phase difference removed signals for each sub band.

As stated before in embodiments of the invention the spectrum of each channel of a multichannel audio signal may be divided into a number of non overlapping sub bands, whereby each sub band comprises a number of frequency coefficients. Further, it is to be understood that that each sub band may be viewed as a frequency bin within the spectrum of the multichannel audio signal. In other words the spectrum for each channel of the multichannel audio signal may be represented as a discrete fourier transform (DFT) with a resolution equivalent to the width of the sub band. Consequently, a sub band (or frequency bin) may be represented as a single sinusoid with a specific magnitude and phase, in other words a DFT coefficient.

For embodiments of the invention which deploy a two channel multichannel audio signal, the phase difference removed signal for each sub band k for a pair channels, channel 1 and channel 2, may be expressed in the DFT domain as:

$${\hat{S}}_{k}^{1} = {S}_{k}^{1} {e}^{j \frac{1}{2} {α}_{12} ( k )} ; and$$

$${\hat{S}}_{k}^{2} = {S}_{k}^{2} {e}^{- j \frac{1}{2} {α}_{12} ( k )} ,$$

where Sₖ¹ and Sₖ² represent the equivalent DFT coefficients of a sub band k for the first channel and second channel respectively. The term α₁₂(k) represents the estimate of the phase difference as described above between a first channel and second channel for a sub band k. Finally, the terms Ŝₖ¹ and Ŝₖ² denote the phase difference removed equivalent DFT coefficients of a sub band k for a first channel and second channel respectively.

In a vector space, this has the effect of rotating the channel DFT coefficient within each sub band such that they become aligned in the same direction. This procedure is similar to the principal component analysis approach adopted by the UDT methodology for coding multichannel audio cues.

It is to be understood that in embodiments of the invention there may be a number of phase difference removed signals for each sub band k and channel n, whereby each phase difference removed signal is derived using a different estimate of the phase difference. For example, in embodiments of the invention which determine a first estimate and second estimate of the phase difference there may be two separate phase difference removed signals per sub band per channel, and consequently each channel may have two sets of phase difference removed equivalent DFT coefficients per sub band k.

The processing steps of determining the sub band phase difference removed signals for each estimate of the phase difference may be depicted as processing steps 1009 and 1011 in FIG. 9.

Once all the phase difference removed DFT coefficients for each sub band and each channel have been calculated a reliability measure may be calculated corresponding to each estimate of the phase difference within the sub band. This may be performed in order to select which of the number of phase difference removed DFT coefficients is going to represent the sub band.

In embodiments of the invention the reliability of a particular estimate of the phase difference may be calculated by considering the correlations between the phase difference removed signals for the first and second channels. It is to be understood that this is performed for each sub band within the multichannel audio signal.

In embodiments of the invention the correlation based reliability measure may be determined using the same calculation as that used to find the inter channel coherence cue. In other words the reliability measure may be determined as the normalised correlation coefficient between the phase difference removed signals for the first and second channels. For example the normalised, correlation coefficient between the phase difference removed signals for the first and second channels may be determined in an embodiment of the invention by using the following expression,

$${Φ}_{12} ( k ) = \frac{{\hat{S}}_{k}^{1} \cdot {\hat{S}}_{k}^{2}}{\sqrt{( {\hat{S}}_{k}^{1} \cdot {\hat{S}}_{k}^{2} ) ( {\hat{S}}_{k}^{1} \cdot {\hat{S}}_{k}^{2} )}} ,$$

where Φ₁₂ (k) is the normalised correlation coefficient between the phase difference removed signals for the first and second channels for each sub band k.

It is to be understood that for each sub band k a number of reliability measures may be calculated, where each reliability measure corresponds to a separate estimate of the phase difference.

The process of generating a reliability measure for each estimate within each sub band is depicted for the case of a first and second estimate as processing steps 1013 and 1015 in FIG. 9.

Each reliability measure may then be evaluated on a per sub band basis in order to determine the most appropriate phase difference estimate for the sub band. The selected estimate may then be used as the phase difference cue for the particular sub band.

In embodiments of the invention the reliability measures for each sub band may be evaluated by noting the value of the normalised cross correlation coefficients obtained for each measure and simply selecting the particular estimate of the phase difference to be used as the selected phase difference cue for the sub band with the highest normalised correlation coefficient value.

In a first embodiment of the invention which calculates a first and second estimate for the phase difference for each sub band, and where the first estimate of the phase difference is formed by filtering past selected phase differences and the second estimate is determined by the magnitude of the frequency coefficients in the sub band. Then if the normalised cross correlation coefficient value associated with the first estimate for the phase difference is above a predetermined threshold it may be considered as reliable and the first estimate may accordingly be selected as the phase difference cue for the sub band.

It is to be understood in a first embodiment of the invention the second estimate of the phase difference may only be determined when the first estimate is deemed unreliable on producing a reliability measure which is below the predetermined threshold. In this instance the second estimate of the phase difference will be selected as the phase difference cue for the sub band.

In the first embodiment of the invention the second estimate of the phase difference has the effect of ensuring that the parameter track produced by the first estimate filtering mechanism does not drift to a sub optimal value. This may be especially prevalent when the filter memories are initialised. In this scenario the choice of the second estimate for the phase difference behaves as a filter reset by pulling the memory path of the filter onto a different parameter track.

The process of evaluating the reliability measures for each estimate of the phase difference and then selecting a particular estimate of the phase difference depending on the evaluation is shown as processing steps 1017 and 1019 in FIG. 10.

In embodiments of the invention the past, previous, or preceding selected phase difference filtering mechanism may be arranged in the form of a first-in-first-out (FIFO) buffer. In this case each FIFO buffer memory store contains a number of past selected phase differences for a particular sub band, whereby the most recent values are at the start of the buffer and the oldest values at the end of the buffer. The past selected values stored within the buffer may then be filtered in order to generate the target phase difference value for the subframe.

It is to be understood that each buffer memory store for a particular sub band may correspond to a selected phase difference for a previous audio processing analysis frame.

Once the selected phase difference value for a particular sub band has been determined for a current audio analysis frame the memory of the filter may be updated. The updating process may take the form of removing the oldest selected phase difference from the end of the buffer and adding the newly selected phase difference corresponding to the current audio analysis frame to the beginning of the buffer.

In some embodiments of the invention updating the FIFO buffer memory with the newly selected phase difference for a particular sub band may take place for every audio analysis frame.

In further embodiments of the invention the FIFO buffer memory updating process for each sub band may be conditional upon certain criteria being met.

In a first embodiment of the invention the FIFO buffer memory store may be only updated when the normalised cross correlation value corresponding to the best phase difference estimate has achieved a predetermined threshold. For example in the first embodiment of the invention a predetermined threshold value of 0.6 has been determined experimentally to produce an advantageous result.

The step of updating the memory of the filter is shown as processing step 1021 in FIG. 10.

Finally, the selected phase difference for each sub band may be converted to the corresponding ICTD by the application of the appropriate discrete angular frequency value associated with the sub band in question.

In embodiments of the invention the conversion from a phase difference value to the ICTD for each sub band k may take the form of normalising the selected phase difference by the corresponding discrete angular frequency associated with the sub band.

In embodiments of the invention the discrete angular frequency associated with the sub band k may be expressed as:

$$\frac{2 π k}{K} ,$$

where the ratio k/K represents the fraction of the total spectral width of the multichannel audio signal within which the centre of the sub band k lies. In other words the ICTD between a channel pair for a sub band k with a selected estimate of phase difference \hat{α}₁₂(k) may be determined to be:

$${τ}_{12} ( k ) = {\hat{α}}_{12} ( k ) \cdot \frac{K}{2 π k} .$$

The process of calculating the time delay for each sub band between an audio signal from a first channel audio signal and a second channel audio signal by scaling the selected estimated value of the phase difference is depicted as processing step 1023 in FIG. 10.

It is to be understood in those embodiments of the invention which deploy two audio signal channels that the first audio channel and second audio channel may form a channel pair. For example they may comprise a left and a right channel of a stereo pair.

The process of determining the ICTD on a per sub band basis for a pair of audio channels from a multi channel audio signal is depicted as processing step 909 in FIG. 9.

The ICC between the two signals may also be determined by considering the normalised cross correlation function Φ₁₂. For example the ICC c₁₂ between the two sub band signals \tilde{x}₁(k) and \tilde{x}₂(k) may be determined to be the value of the normalised correlation function according to the following expression:

$${c}_{12} = {max}_{{α}_{12}} \vert {Φ}_{12} ( k , {α}_{12} ) \vert .$$

In other words the ICC for a sub band k may be determined to be the absolute maximum of the normalised correlation between the two phase removed signals for different values of estimated phase difference \hat{α}₁₂(k).

In embodiments of the invention the ICC data may correspond to the coherence of the binaural signal. In other words the ICC may be related to the perceived width of the audio source, so that if an audio source is perceived to be wide then the corresponding coherence between the left and right channels may be lower when compared to an audio source which is perceived to be narrow. For example, the coherence of a binaural signal corresponding to an orchestra may be typically lower than the coherence of a binaural signal corresponding to a single violin. Therefore in general an audio signal with a lower coherence may be perceived to be more spread out in the auditory space.

The process of determining the ICC on a per sub band basis for a pair of audio channels from a multi channel audio signal is depicted as processing step 911 in FIG. 9.

Further embodiments of the invention may deploy multiple input audio signals comprising more than two channels into the encoder 104. In these embodiments it may be sufficient to define the ICTD and ICLD values between a reference channel, for example channel 1, and each other channel in turn.

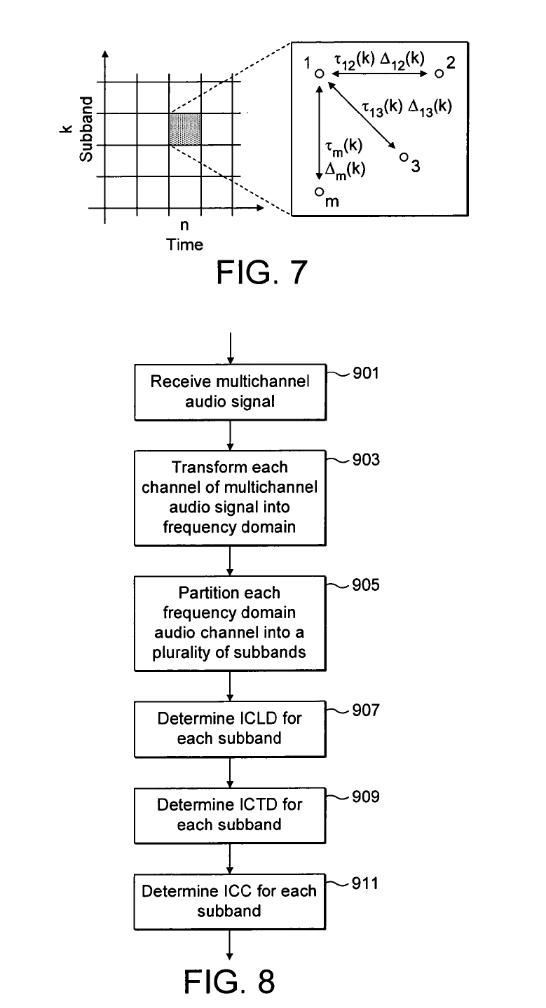

FIG. 7 illustrates an example of a multichannel audio signal system comprising M input channels for a time instance n and for a sub band k. In this example the distribution of ICTD and ICLD values for each channel are relative to channel 1 whereby for a particular sub band k, τ₁ᵢ(k) and ΔL₁ᵢ(k) denotes the ICTD and ICLD values between the reference channel 1 and the channel i.

In the embodiments of the invention which deploy an audio signal comprising of more than two input channels a single ICC parameter per sub band k may be used in order to represent the overall coherence between all the audio channels for a sub band k. This may be achieved by estimating the ICC cue between the two channels with the greatest energy on a per each sub band basis.

The process of estimating the spatial audio cues is depicted as processing step 404 in FIG. 4.

Upon completion of determining the spatial audio cues for the multi channel audio signal the spatial cue analyser 305 may then be arranged to quantile and code the auditory cue information in order to form the side information in preparation for either storage in a store and forward type device or for transmission to the corresponding decoding system.

In embodiments of the invention the ICLD and ICTD for each sub band may be naturally limited according to the dynamics of the audio signal. For example, the ICLD may be limited to a range of ±ΔLₘₐₓ where ΔLₘₐₓ may be 18 dB, and the ICTD may be limited to a range of ±τₘₐₓ where τₘₐₓ may correspond to 800 μs. Further the ICC may not require any limiting since the parameter may be formed of normalised correlation which has a range between 0 and 1.

After limiting the spatial auditory cues the spatial analyser 305 may be further arranged to quantize the estimated inter channel cues using uniform quantizers. The quantized values of the estimated inter channel cues may then be represented as a quantization index in order to facilitate the transmission and storage of the inter channel cue information.

In some embodiments of the invention the quantisation indices representing the inter channel cue side information may be further encoded using run length encoding techniques such as Huffman encoding in order to improve the overall coding efficiency.

The process of quantising and encoding the spatial audio cues is depicted as processing step 406 in FIG. 4.

The spatial cue analyser 305 may then pass the quantization indices representing the inter channel cue as side information to the bit stream formatter 309. This is depicted as processing step 408 in FIG. 4.

In embodiments of the invention the sum signal output from the down mixer 303 may be connected to, the input of an audio encoder 307. The audio encoder 307 may be configured to code the sum signal in the frequency domain by transforming the signal using a suitably deployed orthogonal based time to frequency transform, such as a modified discrete cosine transform (MDCT) or a discrete fourier transform (DFT). The resulting frequency domain transformed signal may then be divided into a number or sub bands, whereby the allocation of frequency coefficients to each sub band may be apportioned according to psychoacoustic principles. The frequency coefficients may then be quantised on a per sub band basis. In some embodiments of the invention the frequency coefficients per sub band may be quantised using a psychoacoustic noise related quantisation levels in order to determine the optimum number of bits to allocate to the frequency coefficient in question. These techniques generally entail calculating a psychoacoustic noise threshold for each sub band, and then allocating sufficient bits for each frequency coefficient within the sub band in order ensure that the quantisation noise remains below the pre calculated psychoacoustic noise threshold. In order to obtain further compression of the audio signal, audio encoders such as those represented by 307 may deploy run length encoding on the resulting bit stream. Examples of audio encoders represented by 307 known within the art may include the Moving Pictures Expert Group Advanced Audio Coding (AAC) or the MPEG1 Layer III (MP3) coder.

The process of audio encoding of the sum signal is depicted as processing step 403 in FIG. 4.

The audio encoder 307 may then pass the quantization indices associated with the coded sum signal to the bit stream formatter 309. This is depicted as processing step 405 in FIG. 4.

The bitstream formatter 309 may be arranged to receive the coded sum signal output from the audio encoder 307 and the coded inter channel cue side information from the spatial cue analyser 305. The bitstream formatter 309 may then be further arranged to format the received bitstreams to produce the bitstream output 112.

In some embodiments of the invention the bitstream formatter 234 may interleave the received inputs and may generate error detecting and error correcting codes to be inserted into the bitstream output 112.

The process of multiplexing and formatting the bitstreams for either transmission or storage is shown as processing step 410 in FIG. 4.

It is to be understood in embodiments of the invention that the multichannel audio signal may be transformed into a plurality of sub band multichannel signals for the application of the spatial audio cue analysis process, in which each sub band may comprise a granularity of at least one frequency coefficient.

It is to be further understood that in other embodiments of the invention the multichannel audio signal may be transformed into two or more sub band multichannel signals for the application of the spatial audio cue analysis process, in which each sub band may comprise a plurality of frequency coefficients.

Although the above examples describe embodiments of the invention operating within a codec within an electronic device 10 or apparatus, it would be appreciated that the invention as described below may be implemented as part of any variable rate/adaptive rate audio (or speech) codec. Thus, for example, embodiments of the invention may be implemented in an audio codec which may implement audio coding over fixed or wired communication paths.

Thus user equipment may comprise an audio codec such as those described in embodiments of the invention above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. A method comprising:
determining at least one current phase difference between a first channel audio signal and a second channel audio signal for a current audio frame;
calculating at least one phase difference estimate dependent on the at least one phase difference;
determining a reliability value for each phase difference estimate by:
determining a phase difference removed first channel audio signal by adapting the phase of the first channel audio signal by an amount corresponding to a first portion of the at least one phase difference estimate;
determining a phase difference removed second channel audio signal by adapting the phase of the second channel audio signal by an amount corresponding to a second portion of the at least one phase difference estimate; and
calculating a normalised correlation coefficient between the phase difference removed first channel audio signal and the phase difference removed second audio channel audio signal; and wherein the method further comprises determining at least one time delay value dependent on the reliability value for each phase difference estimate.

2. (canceled)

3. (canceled)

4. The method as claimed in claim 1, wherein determining the at least one time delay value comprises:
determining a maximum reliability value from the reliability value for each of the at least one phase difference estimate;
determining at least one further phase difference estimate from the at least one phase difference estimate associated with the maximum reliability value; and
calculating the at least one time delay value by applying a scaling factor to the at least one further phase difference estimate.

5. The method as claimed in claim 1, wherein calculating the at least one phase difference estimate comprises at least one of the following:
calculating a first of the at least one phase difference estimate dependent on the at least one phase difference; and
calculating a second of the at least one phase difference estimate dependent on the at least one phase difference.

6. The method as claimed in claim 1, wherein determining the at least one time delay value comprises:
determining whether the reliability value associated with the first of the at least one phase difference estimate is equal or above a predetermined value;
assigning at least one further phase difference estimate to be the value of the first of the at least one phase difference estimate, wherein the assignment is dependent on the determination of the reliability value associated with the first of the at least one phase difference estimate; and
calculating the at least one time delay value by applying a scaling factor to the at least one further phase difference estimate.

7. The method as claimed in claim 1, wherein determining the at least one time delay value comprises:
determining whether the reliability value associated with the first of the at least one phase difference estimate is below a predetermined value;
assigning at least one further phase difference estimate to be the value of the first of the at least one phase difference estimate, wherein the assignment is dependent on the determination of the reliability value associated with the first of the at least one phase difference estimate; and
calculating the at least one time delay value by applying a scaling factor to the at least one further phase difference estimate.

8. The method as claimed in claim 6, wherein the scaling factor is a phase to time scaling factor.

9. The method as claimed in claim 5, wherein calculating the first of the at least one phase difference estimate comprises:
providing a target phase value dependent on at least one preceding phase difference;
calculating at least one distance value wherein each distance value is associated with one of the at least one current phase difference and the target phase value;
determining a minimum distance value from the at least one distance measure value; and
assigning the first of the at least one phase difference to be the at least one current phase difference associated with the minimum distance value.

10. The method as claimed in claim 9, wherein providing the target phase value comprises at least one of the following:
determining the target phase value from a median value of the at least one preceding phase difference value; and
determining the target phase value from a moving average value of the at least one preceding phase difference value.

11. The method as claimed in claim 9, wherein calculating each of the at least one distance value comprises:
determining the difference between the target value and the associated at least one current phase difference.

12. The method as claimed in claim 9, wherein the at least one preceding phase difference corresponds to at least one further phase estimate associated with a previous audio frame wherein the at least one preceding phase difference is updated with the further phase estimate for the current frame, and wherein the updating of the at least one preceding phase difference with the further phase estimate for the current frame is dependent on whether the maximum reliability value is greater than a predetermined value.

13. (canceled)

14. (canceled)

15. The method as claimed in claim 1, wherein determining the at least one current phase difference between a first channel audio signal and a second channel audio signal for a current audio frame comprises;
transforming the first channel audio signal into a first frequency domain audio signal comprising at least one frequency domain coefficient;
transforming the second channel audio signal into a second frequency domain audio signal comprising at least one frequency domain coefficient; and
determining the difference between the at least one frequency domain coefficient from the first frequency domain audio signal and the at least one frequency domain coefficient from the second frequency domain audio signal.

16. The method as claimed in claim 15, wherein calculating the second of the at least one phase difference estimate dependent on the at least one phase difference comprises:
determining the at least one current phase difference associated with at least one of the following;
a maximum magnitude frequency domain coefficient from the first frequency domain audio signal; and
a maximum magnitude frequency domain coefficient from the second frequency domain audio signal.

17. The method as claimed in claim 15, wherein the at least one frequency coefficient is a complex frequency domain coefficient comprising a real component and an imaginary component, and wherein determining the phase from the frequency domain coefficient comprises:
calculating the argument of the complex frequency domain coefficient, wherein the argument is determined as the arc tangent of the ratio of the real component to the imaginary component.

18. The method as claimed in claim 17, wherein the complex frequency domain coefficient is a discrete fourier transform coefficient.

19. The method as claimed in claim 1, wherein the audio frame is partitioned into a plurality of sub bands, and the method is applied to each sub band and wherein the phase to time scaling factor is a normalised discrete angular frequency of a sub band signal associated with a corresponding sub band of the plurality of sub bands.

20. (canceled)

21. The method as claimed in claim 1, wherein the at least one time delay value is an inter channel time delay as part of a binaural cue coder.

22. An apparatus comprising a processor configured to:
determine at least one current phase difference between a first channel audio signal and a second channel audio signal for a current audio frame;
calculate at least one phase difference estimate dependent on the at least one phase difference;
determine a reliability value for each phase difference estimate by;
determining a phase difference removed first channel audio signal by adapting the phase of the first channel audio signal by an amount corresponding to a first portion of the at least one phase difference estimate;
determining a phase difference removed second channel audio signal by adapting the phase of the second channel audio signal by an amount corresponding to a second portion of the at least one phase difference estimate; and
calculating a normalised correlation coefficient between the phase difference removed first channel audio signal and the phase difference removed second audio channel audio signal and wherein the apparatus is further configured to
determine at least one time delay value dependent on the reliability value for each phase difference estimate.

23. (canceled)

24. (canceled)

25. The apparatus as claimed in claim 22, wherein the apparatus configured to determine the at least one time delay value is further configured to:
determine a maximum reliability value from the reliability value for each of the at least one phase difference estimate;
determine at least one further phase difference estimate from the at least one phase difference estimate associated with the maximum reliability value; and
calculate the at least one time delay value by applying a scaling factor to the at least one further phase difference estimate.

26. The apparatus as claimed in claim 22, wherein the apparatus configured to calculate the at least one phase difference estimate dependent on the at least one phase difference is further configured to calculate at least one of the following:
a first of the at least one phase difference estimate dependent on the at least one phase difference; and
a second of the at least one phase difference estimate dependent on the at least one phase difference.

27. The apparatus as claimed in claim 22, wherein the apparatus configured to determine the at least one time delay value is further configured to:
determine whether the reliability value associated with the first of the at least one phase difference estimate is equal or above a predetermined value;
assign at least one further phase difference estimate to be the value of the first of the at least one phase difference estimate, wherein the assignment is dependent on the determination of the reliability value associated with the first of the at least one phase difference estimate; and
calculate the at least one time delay value by applying a scaling factor to the at least one further phase difference estimate.

28. The apparatus as claimed in claim 22, wherein the apparatus configured to determine the at least one time delay value is further configured to:
determine whether the reliability value associated with the first of the at least one phase difference estimate is below a predetermined value;
assign at least one further phase difference estimate to be the value of the first of the at least one phase difference estimate, wherein the assignment is dependent on the determination of the reliability value associated with the first of the at least one phase difference estimate; and
calculate the at least one time delay value by applying a scaling factor to the at least one further phase difference estimate.

29. The apparatus as claimed in claim 27, wherein the scaling factor is a phase to time scaling factor.

30. The apparatus as claimed in claim 26, wherein the apparatus configured to calculate the first of the at least one phase difference estimate is further configured to:
provide a target phase value dependent on at least one preceding phase difference;
calculate at least one distance value wherein each distance value is associated with one of the at least one current phase difference and the target phase value;
determine a minimum distance value from the at least one distance measure value; and
assign the first of the at least one phase difference to be the at least one current phase difference associated with the minimum distance value.

31. The apparatus as claimed in claim 30, wherein the apparatus configured to provide the target phase value is further configured to determine at least one of the following:
the target phase value from a median value of the at least one preceding phase difference value; and
the target phase value from a moving average value of the at least one preceding phase difference value.

32. The apparatus as claimed in claim 30, wherein the apparatus configured to calculate each of the at least one distance value is further configured to:
determine the difference between the target value and the associated at least one current phase difference.

33. The apparatus as claimed in claim 30, wherein the at least one preceding phase difference corresponds to at least one further phase estimate associated with a previous audio frame wherein the at least one preceding phase difference is updated with the further phase estimate for the current frame, and wherein the updating of the at least one preceding phase difference with the further phase estimate for the current frame is dependent on whether the maximum reliability value is greater than a predetermined value.

34. (canceled)

35. (canceled)

36. The apparatus as claimed in claim 22, wherein the apparatus configured to determine the at least one current phase difference between a first channel audio signal and a second channel audio signal for a current audio frame is further configured to;
transform the first channel audio signal into a first frequency domain audio signal comprising at least one frequency domain coefficient;
transform the second channel audio signal into a second frequency domain audio signal comprising at least one frequency domain coefficient; and
determine the difference between the at least one frequency domain coefficient from the first frequency domain audio signal and the at least one frequency domain coefficient from the second frequency domain audio signal.

37. The apparatus as claimed in claim 36, wherein the apparatus configured to calculate the second of the at least one phase difference estimate dependent on the at least one phase difference is further configured to:
determine the at least one current phase difference associated with at least one of the following;
a maximum magnitude frequency domain coefficient from the first frequency domain audio signal; and
a maximum magnitude frequency domain coefficient from the second frequency domain audio signal.

38. The apparatus as claimed in claim 36, wherein the at least one frequency coefficient is a complex frequency domain coefficient comprising a real component and an imaginary component, and wherein the apparatus configured to determine the phase from the frequency domain coefficient is further configured to:
calculate the argument of the complex frequency domain coefficient, wherein the argument is determined as the arc tangent of the ratio of the real component to the imaginary component.

39. The apparatus as claimed in claim 38, wherein the complex frequency domain coefficient is a discrete fourier transform coefficient.

40. The apparatus as claimed in claim 22, wherein the audio frame is partitioned into a plurality of sub bands, and the apparatus is configured to process each sub band, and wherein the phase to time scaling factor is a normalised discrete angular frequency of a sub band signal associated with a corresponding sub band of the plurality of sub bands.

41. (canceled)

42. The apparatus as claimed in claim 22, wherein the at least one time delay value is an inter channel time delay as part of a binaural cue coder.

43. (canceled)

44. (canceled)

45. (canceled)

46. (canceled)

47. A computer-readable storage medium carrying one or more sequences of one or more instructions which, when executed by one or more processors, cause an apparatus to:
determine at least one current phase difference between a first channel audio signal and a second channel audio signal for a current audio frame;
calculate at least one phase difference estimate dependent on the at least one phase difference;
determine a reliability value for each phase difference estimate by:
determining a phase difference removed first channel audio signal by adapting the phase of the first channel audio signal by an amount corresponding to a first portion of the at least one phase difference estimate;
determining a phase difference removed second channel audio signal by adapting the phase of the second channel audio signal by an amount corresponding to a second portion of the at least one phase difference estimate; and
calculating a normalised correlation coefficient between the phase difference removed first channel audio signal and the phase difference removed second audio channel audio signal and wherein the one or more sequences of one or more instructions further cause the apparatus to
determine at least one time delay value dependent on the reliability value for each phase difference estimate.
